(19) United States
(12) Patent Application Publication
(10) Pub. No.: US 2005/0226330 A1
(43) Pub. Date: Oct. 13, 2005

(54) Method and apparatus for motion compensated temporal interpolation of video sequences

(76) Inventors: Wilhelmus Hendrikus Alfonus Bruls, Eindhoven (NL); Frederik Jan De Bruijn, Eindhoven (NL); Gerard De Haan, Eindhoven (NL); Dzevdet Burazerovic, Eindhoven (NL); Gerardus Johannes Maria Vervoort, Eindhoven (NL)

Correspondence Address: US Philips Corporation;Intellectual Property Department, PO Box 3001, Briarcliff Manor, NY, 10510, US

(21) Appl. No.: 10/498,953

(22) PCT Filed: Dec. 16, 2002
(86) PCT No.: PCT/IB02/05500

§ 371 Date: Jun. 16, 2004

(30) Foreign Application Priority Data
Dec. 21, 2001 (EP) 01205131.4
May 24, 2002 (EP) 02077035.0

(51) Int. Cl. H04N 7/12

(52) U.S. Cl. 375/240.16; 375/240.21

(57) ABSTRACT

Method for encoding a digital video stream, comprising the steps of encoding a video sequence into a full frame sequence, forming a decimated frame sequence by removing a predetermined number of frames from the full frame sequence by means of temporal decimation, locally decoding the full frame sequence, locally decoding the decimated frame sequence, temporally interpolating the decoded decimated frame sequence by means of an interpolator, comparing the locally decoded frames of the full frame sequence with the corresponding frames of the locally interpolated frame sequence, determining residual information for a frame based on at least the comparison for that frame, and providing an output stream comprising the decimated frame sequence and the determined residual information.

The invention relates to a method for encoding and decoding video data. When encoding a video signal to make it suitable for digital handling, such as transmission or storage, compression of the video data is used to optimize the use of available bandwidth and storage capacity. The good compression results are obtained with lossy encoding, wherein information of the original signal can not be fully recovered in the decoding stage.

Although with lossy encoding good results can be obtained, it is an object of the invention to provide an encoding method with which better compression results can be obtained. Better performance can lie in that with a similar compression rate or bandwidth, better decoded results are obtained or that similar decoded result is obtained with a better compression rate or smaller bandwidth. To obtain this objective, a method for encoding a video signal is provided according to claim 1.

From a video stream to be encoded a decimated frame sequence is formed by removing a number of frames of the video stream. Then the decimated frame sequence is temporally interpolated in order to make a good estimation of the decimated (i.e. skipped) frames. Consecutively, areas of the skipped-estimated frames are detected in which the estimation is inadequate, in that it does not meet a predetermined standard. By comparing the in the encoder still available skipped frame with the skipped-estimated frames, these areas can be detected, and residual information can be determined. Only the decimated frame sequence and the residual data for the detected areas will now be encoded, and inserted in an encoded bitstream. Preferably, the temporal interpolation is performed on locally decoded encoded frames of the decimated frame sequence in order to perform the temporal interpolation a frames that are also available in a decoder.

An encoded bitstream is decoded according to the invention, by extracting the residual data from the main bitstream. Consequently, the main bitstream data is interpolated using a similar interpolating process as used for the encoding. The residual data is then added to the interpolated frame sequence.

By using the encoding/decoding system according to the invention, a better quality/bandwidth ration can be obtained, because only relevant residual data is incorporated into the encoded signal.

The invention further relates to a method for decoding, an encoder, a decoder, an audiovisual device, a data container device, a computer program and a data carrier device on which a computer program is stored.

Particularly advantageous elaborations of the invention are set forth in the dependent claims. Further objects, elaborations, modifications, effects and details of the invention appear from the following description, in which reference is made to the drawing, in which

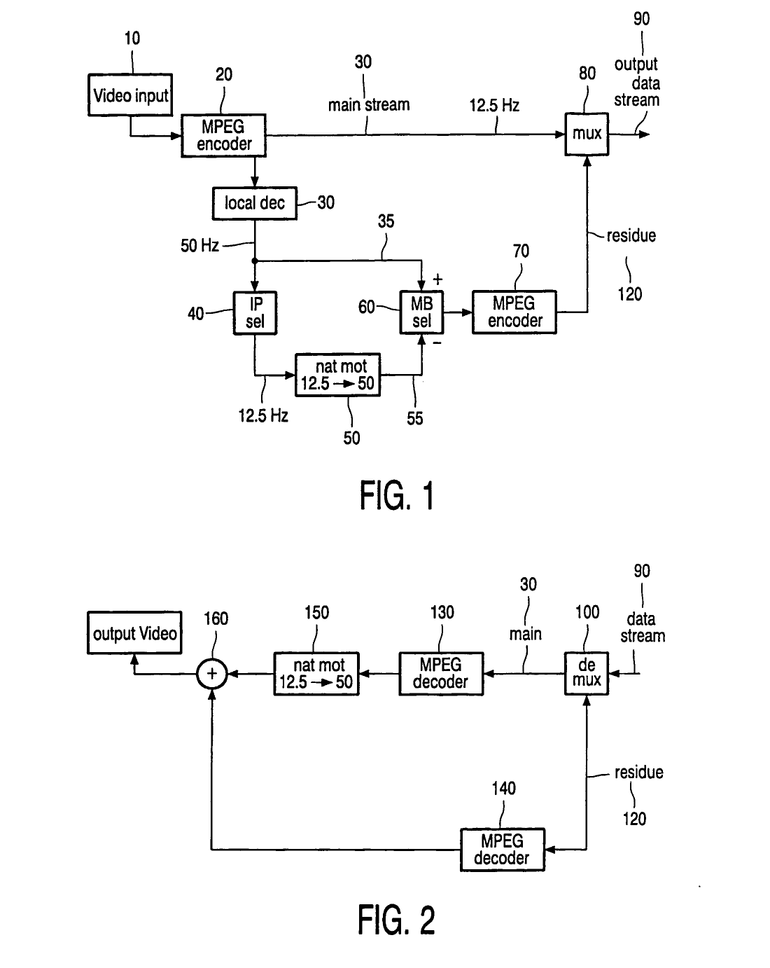

FIG. 1 shows a flow diagram of an encoding method according to the invention,

FIG. 2 shows a flow diagram of a decoding method according to the invention for use in combination with the method of FIG. 1,

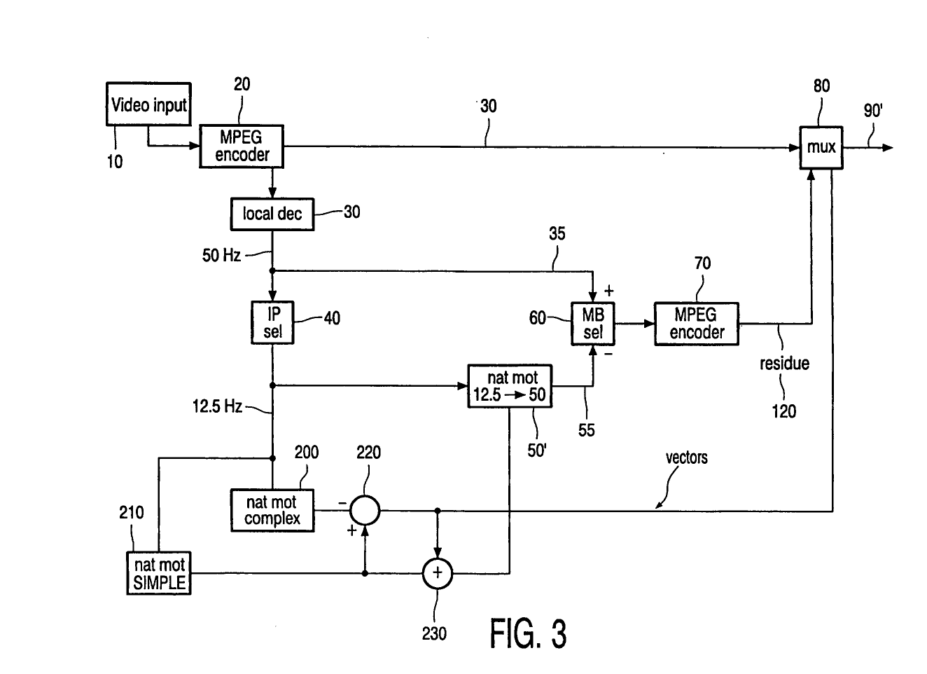

FIG. 3 shows a flow diagram of another encoding method according to the invention,

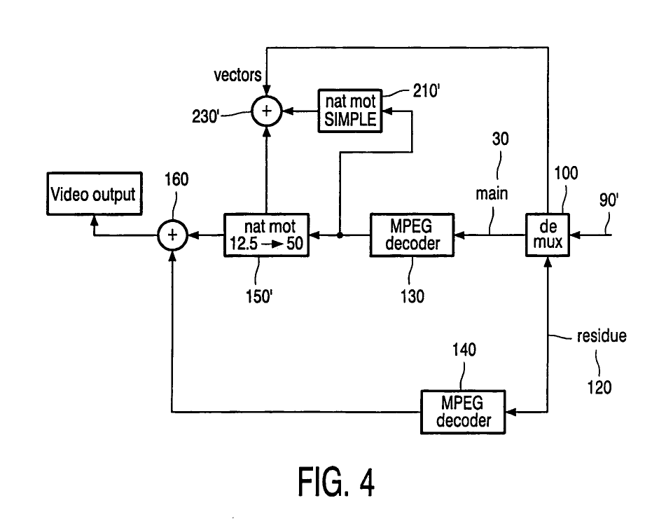

FIG. 4 shows a flow diagram of a decoding method according to the invention for use in combination with the method of FIG. 3,

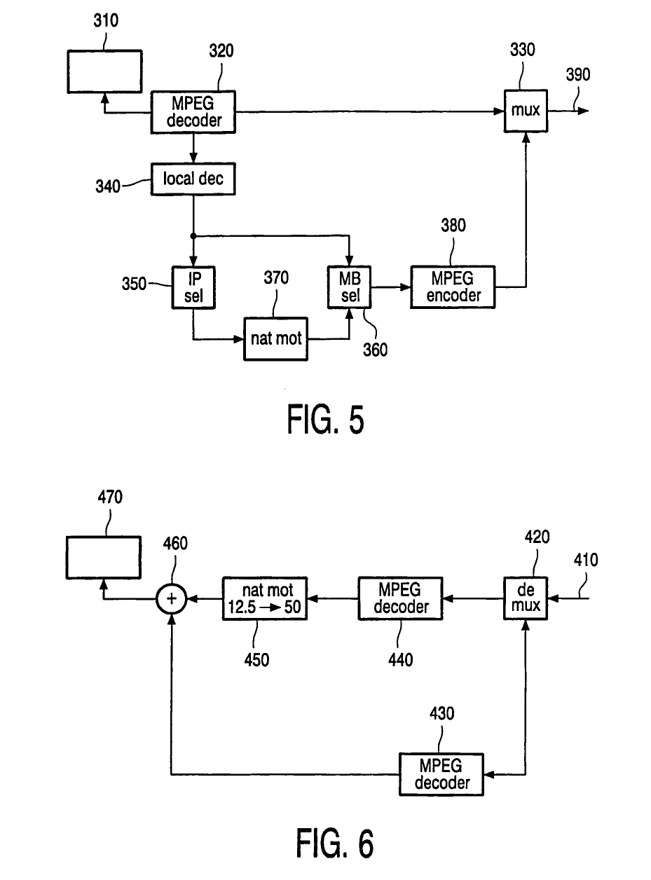

FIG. 5 shows an example of an encoder according to the invention,

FIG. 6 shows an example of a decoder according to the invention.

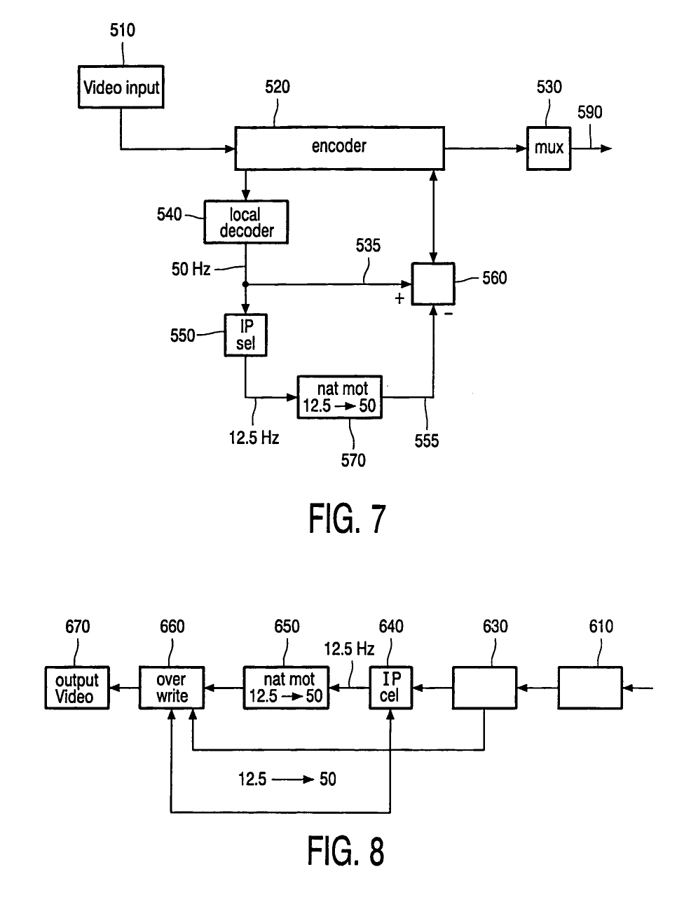

FIG. 7 shows a block diagram of an example of an embodiment of another encoder according to the invention, and

FIG. 8 shows a block diagram of an example of an embodiment of another encoder according to the invention.

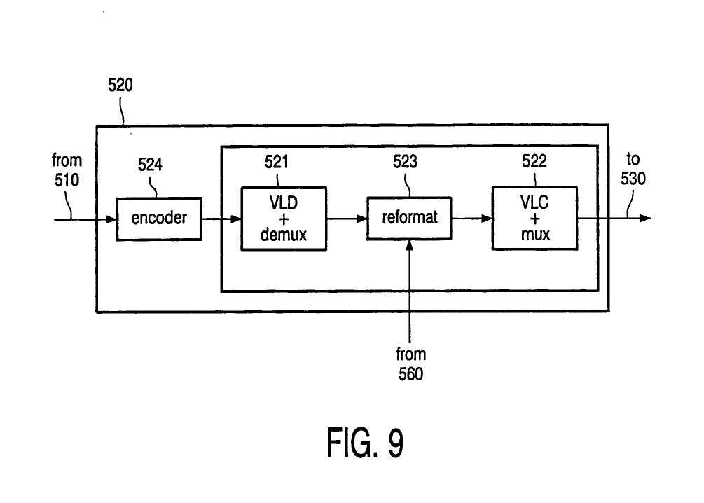

FIG. 9 shows a block diagram of an example of a video encoder which may be used in example of an encoder according to the invention of FIG. 7.

In FIG. 1 a flow diagram is shown of an example of a encoding method according to the invention. A video input signal 10 comprising a video sequence is supplied to an video encoder, in this example a MPEG encoder 20. The encoder 20 codes the video signal in a specific digital format, in this example a MPEG format. The encoded signal consists of a sequence of frames, such as an IPP sequence in MPEG. The encoder 20 performs a temporal decimation during the coding which means that a predetermined number of the frames are skipped or discarded. As an example the input video signal is a 50 Hz signal, whereas the outputted main stream output signal 30 is a 12.5 Hz signal. The decimating factor is therefore 1 out of 4, meaning that from a sequence of 4 frames a single frame is maintained. It should be noted that this encoding is a standard MPEG operation. Furthermore, the decimating factor can be adjusted, to obtain the required reduction in the data stream.

The encoder 20 also encodes a full encoded data stream, that is without discarding any frames due to temporal interpolation. This data stream is send to a decoder 30, suitable to decode the encoded data stream which in this example means a MPEG decoder. The decoded data stream 35 is a 50 Hz signal, as no frame where dropped in the encoding process. The data stream 35 is provided to an IP selector 40; the selector 40 performs the same temporal elimination as the encoder 20 performs on the original video input. The result is again a 12.5 Hz signal. This reduced signal is fed to a motion estimator 50, that is embodied in this example as a natural motion estimator. The estimator 50 performs a upconversion from 12.5 Hz to 50 Hz by estimating additional frames. The estimator 50 performs the same upconversion as later the decoder will perform when decoding the coded data stream. Any motion estimation method can be employed according to the invention. In particular good results can be obtained with motion estimation based on natural or true motion estimation as used in for example frame-rate conversion methods. A very cost efficient implemention is for example three-dimensional recursive search (3DRS) which is suitable for consumer applications, see for example the U.S. Pat. Nos. 5,072,293, 5,148,269, and 5,212,548. The motion-vectors estimated using 3DRS tend to be equal to the true motion, and the motion-vector field inhibits a high degree of spatial and temporal consistency. Thus, the vector inconsistency is not thresholded very often and consequently, the amount of residual data transmitted is reduced compared to non-true motion estimations.

The upconverted signal 55 is send to an evaluation unit 60 (as indicated with a minus sign). To the evaluation unit also the full data stream 35 is send (as indicated with a plus sign). The evaluation unit 60 compares the interpolated frames as determined by the motion estimator 50 with the actual frames. From the comparison is determined where the estimated frames differ from the actual frames. Differences in the respective frames are evaluated; in case the differences meet certain thresholds, the differential data is selected as residual data. The thresholds can for example be related to noticeable the differences are; such threshold criteria per se are known in the art. In this example the residual data is described in the form of meta blocks. The residual data stream 120 in the form of meta blocks is then put into a MPEG encoder 70. The residual data can be encoded using a private data channel as is provided for within a MPEG environment.

Finally, the main stream of the data and the residual data stream are combined by means of the multiplexer 80 to form a single output data stream 90. The output stream 90 can be transmitted (using for example a (wireless) data transmission connection) or stored or used otherwise.

In FIG. 2 a flow diagram of an example of a method according to the invention to decode the data stream 90 is shown. First, the data stream 90 is de-multiplexed in a demultiplexer 100 into the main data stream 30 and the residual data stream 120. To this end, the demultiplexer is programmed to recognize the residual data stream enclosed in the incoming signal. In case a private data channel is used, the demultiplexer extracts the residual data from the private data channel used. Both the main data stream 30 and the residual data stream are decoded by means of a MPEG decoder, shown respectively in step 130 and 140. The main stream decoded signal is forwarded to a motion estimator, in this example embodied as a natural motion estimator 150. The motion estimator 150, which as such is known in the art, interpolates the data provided, making a 50 Hz signal from the 12.5 Hz signal decoded in the previous step. The upconverted 50 Hz signal is consecutively put forward to an combiner 160.

Apart from the upconverted signal is also the decoded residual data from the decoder 140 forwarded to the combiner 160. The combiner 160 combines the information of the main data stream with the residual data stream. Such an operation per se is known in the art, and comprises replacing information, such as meta blocks, in the main data stream with respective residual information, such as meta blocks. The output signal of the combiner 160 is a 50 Hz frame rate video data stream.

In case the decoder that receives the data stream 90 is not equipped to detect the residual data stream, the main stream only is decoded. Therefore a usable video signal can be decoded, even with a decoder that is not fully compliant with the residual data signal. However, the decoded signal is not as good as the signal obtainable with the residual data correction.

The invention may be applied in various devices, for example a data transmission device, like a radio transmitter or a computer network router that includes input signal receiver means and transmitter means for transmitting a coded signal, such as an antenna or an optical fibre, may be provided with an image encoder device according to the invention that is connected to the input signal receiver means and the transmitter means. Furthermore, a decoder according to the invention can be implemented in for example a DVD recorder, and a PVR (HDD) recorder. An encoding and decoding system according to the invention can be implemented with for example internet video streaming services, and in-home (wireless) networks.

Good results can be obtained for a temporal decimation of 1 out of 2; typically less then 5-10% of the area of the skipped-estimated frames is detected as in need of residual information. Also a decimation of 1 out 4 frames yields good results. Even more frames can be skipped using the invention for applications that do not require the highest image quality.

The invention also relates to an encoder and a decoder for performing the above illustrated coding and decoding methods. In FIG. 5 an example of an encoder according to the invention is shown. It comprises an input section 310 for receiving video data, connected to an encoder 320. The encoder is connected to a multiplexer 330 and to a local decoder 340. The local decoder 340 is connected to a selector 350 and an evaluation unit 360. The selector 350 is connected via an estimator 370 to the selector 350. The selector 350 is connected to the multiplexer via an encoder 380. The multiplexer is connected with an output section 390.

In FIG. 6 an example of a decoder according to the invention is shown. The decoder comprises an input section 410 that is connected to a demultiplexer 420. The demuliplexer 420 is connected to a decoder 440 and 430. Both decoders are connected to a combiner 460; the decoder 430 is connected directly, whereas the decoder 440 is connected via an estimator 450. The estimator 460 is connected with an output section 470.

In FIGS. 3 and 4 a second example of an encoding/decoding system is shown. Parts of the invention that correspond with elements from the example embodiment shown above are noted with the same reference numerals, and for a description of their function referred is to above. The second embodiment differs from the first embodiment in that in an additional natural motion estimator is used in the decoding stage. To this end, two different types of temporal interpolators are used in the encoding stage in the encoder, a simple temporal interpolator and a complex one. The decoder will now only have to use the simple (and relatively cost effective) temporal interpolator. The complex temporal interpolator (which is relatively costly) will only have to be employed in the encoder.

The encoding of the video stream is generally similar in both the first and second embodiment. In the second embodiment (see FIG. 3) an additional step 200 is introduced in which the information from the selector 40 is upconverted in a complex temporal interpolator, for example of the natural motion type, to yield highly accurate interpolations for the decimated frames. This high accuracy data is put forward to an evaluator 220.

Parallel with the high accuracy interpolation, the data is also supplied to a simple temporal interpolator 210, of the type employed by the eventual decoder. The simple interpolator 210 yields a medium accuracy data stream that is provided to the above mentioned evaluator 220. The evaluator 220 compares the high and medium accuracy interpolations and yields a corrected vector stream to the multiplexer to be included in the residual information in for example the private data channel. The vector stream is also provided to a combiner 230 that combines the vector data with the medium accuracy interpolation result of the simple temporal interpolator 210. The combined signal is fed to the natural motion estimator 50′ that uses the information to adjust the interpolated frames. The subsequent residual data determination is similar to the first embodiment.

The resulting encoded data stream comprises the main stream data, the residual data, and the correction vector information. The bandwidth used is therefore slightly larger than in the first embodiment, but better quality results are obtained.

In decoding, shown in FIG. 4, the incoming data is demultiplexed into the main data stream, the residual stream (similar to the first example), and the vector data. The formation of the video output is done in similar fashion to the first embodiment, with the addition that the natural motion estimation 150′ also includes the result from the medium quality estimator 210′ which results are corrected in 230′ by the decoded vectors. By using the additional medium quality estimation, the end result is significantly improved, even more so if the correction vectors are used. The additional costs for obtaining the better quality are relatively small, and consist of an extra simple motion estimation device and a slightly increase bandwidth. Furthermore, an additional high quality estimator is required in the encoding step, but this only marginally increase the cost for the encoder.

In the examples of devices and methods described above, the residual data stream is encoded or decoded using the same type of encoding or decoding as the main data stream. It is likewise possible to encode or decode the residual data using a different type of encoding or decoding. For example, the encoding or decoding of the residual data stream may be specifically adapted to the residual data. In that case, a more efficient encoding may be obtained compared to using the same encoding or decoding for both the main data stream and the residual data stream. The increase of coding efficiency may for example be caused by the difference in correlation between the residual data and the main data, since in general there will be less correlation between consecutive frames in the residual data stream then between consecutive frames in the main data stream.

The encoder for the residual data may be some special or proprietary coding scheme, which may take into account the characteristics of the visual content of the residual data stream. For example, scattered non-empty blocks in the residual data could first be clustered in a larger group.

FIGS. 7 and 8 show block diagrams of an example of an encoder and decoder resp. in which the residual data and the main data are interleaved during coding.

The encoder of FIG. 7 comprises an input section 510 for receiving video data, connected to an video encoder 520, for example a MPEG encoder. The video encoder 520 is connected to a multiplexer 530 and to a local decoder 540. The local decoder 540 is connected to a selector 550 and an evaluation unit 560. The selector 550 is connected via an estimator 570 to the evaluation unit 560. The evaluation unit 560 is connected to the encoder 520. The multiplexer 530 is connected to or has an output section 590.

The video encoder 520 codes the video signal in a specific digital format, in this example a MPEG format. The encoder 520 also provides a full encoded data stream, that is without discarding any frames due to temporal interpolation. This data stream is sent to a decoder 540, suitable to decode the encoded data stream. In this example the decoder 540 is a MPEG decoder. The decoded data stream 535 is a 50 Hz signal, as no frames were dropped in the encoding process. The data stream 535 is provided to an IP selector 550; the selector 540 performs the same temporal elimination as the encoder 520 performs on the original video input. The result is again a 12.5 Hz signal. This reduced signal is fed to a motion estimator 570, that is embodied in this example as a natural motion estimator.

The estimator 570 performs a upconversion from 12.5 Hz to 50 Hz by estimating additional frames. The estimator 570 performs the same upconversion as the decoder will perform when decoding the coded data stream. In this example, the estimator 570 is a natural motion estimator. The upconverted signal 555 is send to an evaluation unit 560 (as indicated with a minus sign). To the evaluation unit 560 also the full data stream 535 is sent (as indicated with a plus sign). The evaluation unit 560 compares the interpolated frames as determined by the motion estimator 570 with the actual frames. From the comparison is determined where the estimated frames differ from the actual frames. The comparison may for example consist of checking the difference between the estimated frame and the actual frame against predetermined criterions.

The differences in the respective frames are evaluated; in case the differences meet certain thresholds reformat code is transmitted by the evaluation unit 560 to the video encoder 520 which indicates how the encoder should rebuild the respective frame. When the estimated frames are similar to the actual frames, the evaluation unit 560 transmits a skip code to the video encoder 520. The video encoder 520 interleaves the data from the evaluation unit 560 with the main data during coding. Thereby high coding efficiency is be achieved while the same components, e.g. the MPEG-2 coder and decoder, are used to encode or decode both the residual data and the main data. Furthermore, the actual frames and the skip code may easily be detected.

FIG. 9 shows an example of an implementation of the video encoder 520. In FIG. 9, the video encoder comprises a encoder device 524, which is connected to a post-processer device, such as for example a Tri-Media® device. The post-processor device comprises variable length encoders 521,522 which are connected via a reformat device 523. The reformat device 523 is connected to the evaluation unit 560 to receive reformatting instructions. The encoder 524 is also connected to the input of the video encoder 520. The encoder 524 encodes a full encoded data stream without discarding any frames, i.e. the second encoder encodes the input without temporal decimation. This data stream is transmitted to the local decoder 540 which is able to decode the full encoded data stream.

In FIG. 8 an example of a decoder according to the invention is shown. The decoder comprises an input section 610 that is connected to a video decoder 630. The video decoder 630 is connected with an output to a selector 640. The selector 640 is directly connected to an overwriter 660. The selector 640 is also connected to an estimator 650. The estimator 650 is connected to the overwriter 660. The overwriter 660 is connected to an output section 670.

The video decoder 630 may decode an encoded data stream and is specifically suited to decode a date stream encoded with the encoder of FIG. 7. The resulting decoded data stream is then transmitted by the video decoder 630 to the selector 640. The selector performs a temporal decimation which corresponds to the temporal decimation of the down-conversion by selector 550 in the encoder of FIG. 7. The decimated data is transmitted by the selector 640 to the estimator 650. The overwriter device decides based on information from the decoder 630 whether to use the data from the estimator 640 or the data which has been dropped by the selector 640.

When the encoder and/or decoder of FIG. 7-9 are MPEG compliant, the skip code may be a skip macro block code as is provided in the MPEG standard. Such a skip macro block code may also be used in other encoder types, since most video coding standards provide a skip code.

Furthermore, a coded block pattern (cbp) code, as is known from section 8.4.5. of Haskell et all., “Digital video; an introduction to MPEG-2”, Kluwer, 1997, may be used. Such a CBP indicates which blocks in a macro-block are empty, that is in MPEG: which block have all zero discrete cosine transforms. Thereby, if only a part of a macro block or a frame is to be replaced with the actual frame or (macro-) block, the other parts may be indicated with the CBP whereby the amount of data is reduced.

If the invention is used in a MPEG context, an efficient choice for the coding of the base frames (i.e. the decimated data stream) is IPP-frame encoding; for the skipped frames B-frame coding is an effective choice, however other choices could be made as well.

In an advantageous embodiment, the full frame video sequence is obtained by temporally interpolating a relatively low frame rate video sequence such as a 24 Hz progressive movie sequence by a further interpolator of higher quality or accuracy than the interpolator used for interpolating the decimated frame sequence, the further interpolator being e.g. the above described complex temporal interpolator or complex natural motion, or a higher accuracy 2-3 pull down algorithm. The further interpolator is preferably a non-real time, offline interpolator. By using, in above embodiments, a higher quality further interpolator for interpolating a relatively low frame rate movie sequence, a movie temporal enhancement layer is created. In a decoder, the movie temporal enhancement layer is used in order to obtain decoded video with reduced movie judder. The decimation of the full frame video sequence can be performed efficiently by taking the low frame rate video sequence as the decimated video sequence directly. The movie temporal enhancement layer can also be combined with a spatial enhancement layer such that a backwards compatible bitstream is created with a spatial and temporal enhancement layer for improved video quality.

The invention is not limited to implementation in the disclosed examples of physical devices, but can likewise be applied in another device. In particular, the invention is not limited to physical devices but can also be applied in logical devices of a more abstract kind or in software performing the device functions. Furthermore, the devices may be physically distributed over a number of apparatuses, while logically regarded as a single device. Also, devices logically regarded as separate devices may be integrated in a single physical device.

The invention may also be implemented in a computer program for running on a computer system, at least including code portions for performing steps of a method according to the invention when run on a computer system or enabling a general propose computer system to perform functions of a computer system according to the invention. Such a computer program may be provided on a data carrier, such as a CD-rom or diskette, stored with data loadable in a memory of a computer system, the data representing the computer program. The data carrier may further be a data connection, such as a telephone cable or a wireless connection transmitting signals representing a computer program according to the invention.

1. A method for encoding a digital video stream, comprising the steps of
providing a full frame video sequence,
forming a decimated frame sequence by removing a number of frames from the full frame sequence by means of temporal decimation,
temporally interpolating the decimated frame sequence by means of an interpolator,
comparing the frames of the full frame sequence with the corresponding frames of the temporally interpolated frame sequence,
determining residual information for a frame based on at least the comparison for that frame, and
providing an output stream comprising the decimated frame sequence and the determined residual information.

2. A method as claimed in claim 1, wherein the decimated frame sequence is compressively encoded.

3. A method according to claim 1, wherein the residual information is encoded in the form of in data blocks.

4. A method according to claim 1, wherein the residual information is encoded in a private data channel.

5. A method according to any claim 1, wherein the temporal interpolation is performed by means of natural or true motion.

6. A method according to claim 1, wherein the predetermined number of frames is 1 out of 2.

7. A method according to claim 1, wherein the number of frames is 1 out of 4.

8. A method as claimed in claim 1, wherein the temporal interpolation is assisted by data other than the decimated frame sequence, such as motion vectors.

9. A method as claimed in claim 1, wherein the full frame video sequence is obtained by temporally interpolating a relatively low frame rate video sequence by means of a further interpolator of higher quality or accuracy than the interpolator used for temporally interpolating the decimated frame sequence.

10. A method as claimed in claim 9, wherein the decimated frame sequence is formed by the low frame rate video sequence directly rather than by removing a number of frames from the full frame sequence.

11. A method for decoding a data stream encoded according to claim 1, comprising
separating from encoded data stream the decimated frame sequence and the determined residual information,
decoding the decimated frame sequence,
temporally interpolating the decoded decimated frame sequence by means of a similar interpolating process used for the encoding,
decoding the residual information, and
combining the residual information and the interpolated frame sequence to form an output data stream.

12. An encoder for encoding digital video data, provided with
an input section for providing a full frame video sequence,
means for forming a decimated frame sequence by removing a number of frames from a full frame sequence received from the input section by means of temporal decimation,
interpolation means for temporally interpolating the decimated frame sequence by means of an interpolator,
comparator means for comparing the frames of the full frame sequence with the corresponding frames of the temporally interpolated frame sequence and for determining residual information for a frame based on at least the comparison for that frame, and
an output section for providing an output stream comprising the decimated frame sequence and the determined residual information.

13. A decoder for decoding digital video data with an input section and an output section, provided with a decoding section arranged to perform decoding according to claim 11.

14. An audiovisual device, comprising data input means, audiovisual output means and a decoder device as claimed in claim 13.

15. A data container device containing data representing an output stream obtained with a method as claimed in claim 1.

16. A computer program including code portions for performing steps of a method as claimed in claim 1.

17. A data carrier device including data representing a computer program as claimed in claim 16.

18. A video data stream comprising a decimated frame sequence and residual information relating to the decimated frame sequence, the residual information being based on the comparison for a respective frame of a by means of an interpolator temporally interpolated frame based on the decimated frame sequence, and the corresponding respective frame of the full frame sequence.
